(19) United States
(12) Patent Application Publication
(10) Pub. No.: US 2022/0266105 A1
(43) Pub. Date: Aug. 25, 2022

(54) WHEELED PERSONAL ROBOTIC OMNI VEHICLE

(71) Applicant: Timothy J. Roszhart, Waukee, IA (US)

(72) Inventor: Timothy J. Roszhart, Waukee, IA (US)

(21) Appl. No.: 17/676,154

(22) Filed: Feb. 19, 2022

Related U.S. Application Data
(60) Provisional application No. 63/151,638, filed on Feb. 20, 2021.

(51) Int. Cl. A63B 55/60; G06V 40/20; G06V 40/10; G06F 21/31; G06F 21/44

(52) U.S. Cl. CPC A63B 55/61; G06V 40/25; G06V 40/10; G06F 21/31; G06F 21/44; A63B 2055/601; A63B 2055/605; A63B 2225/68; A63B 2225/72

(57) ABSTRACT

A personal mobility vehicle configured to be operated in multiple modes is provided. The personal mobility vehicle operates in multiple modes to address multiple needs in a single all-in-one solution. With an omni-directional wheel and folding frame, the personal mobility vehicle can transform into a stand-up scooter, sit-down wheelchair, trike, push-assist cart, or autonomous robotic vehicle, yet is still compact and portable. The personal mobility vehicle also integrates with the user's smartphone to provide affordable, advanced functionality such as autonomous tracking and navigation utilizing the embedded computer vision and artificial intelligence capabilities.

### CROSS-REFERENCE TO RELATED APPLICATIONS

This application claims priority to U.S. Provisional Patent Application No. 63/151,638, filed on Feb. 20, 2021, the entirety of which is hereby incorporated herein by reference.

### FIELD OF THE INVENTION

This invention relates generally to a personal mobility vehicle. In particular, this invention provides for a personal robotic vehicle capable of being reconfigured to operate in multiple modes, including a stand-up scooter, sit-down wheelchair, trike, push-assist cart, or autonomous robotic vehicle.

### BACKGROUND

With recent advancements in battery and electric vehicle technologies, there has been a proliferation in electric mobility solutions in the market. Consumers are increasingly dependent on electric vehicles for both recreation and transportation, whether due to the need for mobility assistance or the desire for faster, more efficient, and more enjoyable transport. However, the existing solutions in the market are limited in utility and versatility, and therefore typically only suited for specific applications or a specific market segment. Other electric mobility solutions are limited to specific use-cases and modes of operation (i.e., golf carts, golf trolleys, e-bikes, scooters, self-balancing hoverboards, wheelchairs, etc.).

For at least these reasons, an improved personal mobility vehicle is desired. The disclosed invention, referred to as the ProV3, addresses these deficiencies with a versatile lifestyle mobility vehicle that is safe, stable, smart, simple, fun, functional, fast, and affordable for users of all demographics across many varied venues (golf course, a campus, a conference center, or a factory complex for example) and applications. The ProV3 is a smart personal mobility solution that will transform how people and their things get around.

### BRIEF SUMMARY

In accordance with various embodiments of the invention, a personal mobility vehicle, referred to as the ProV3, configured to be operated in multiple modes is provided. The ProV3 operates in multiple modes to address multiple needs in a single all-in-one solution. With an omni-directional wheel and folding frame, the ProV3 can transform into a stand-up scooter, sit-down wheelchair, trike, push-assist cart, autonomous robotic vehicle, or other configurations, yet is still compact and portable. The ProV3 also integrates with the user's smartphone to provide affordable, advanced functionality such as autonomous tracking and navigation utilizing the embedded computer vision and artificial intelligence capabilities.

### BRIEF DESCRIPTION OF THE DRAWINGS

Having thus described the invention in general terms, reference will now be made to the accompanying drawings, which are not necessarily drawn to scale, and wherein:

FIG. 1 illustrates a personal mobility vehicle in a stand and ride mode with a golf bag attachment in accordance with an embodiment of the invention.

FIG. 2a illustrates an omnidirectional wheel with nested rollers in accordance with an embodiment of the invention.

FIG. 2b illustrates the omnidirectional wheel with rollers removed from view in accordance with an embodiment of the invention.

FIG. 2c illustrates a cross-sectional view of an assembled omnidirectional wheel in accordance with an embodiment of the invention.

FIG. 3a illustrates a smartphone used as a connected intelligent vehicle head unit in a front-facing configuration in accordance with an embodiment of the invention.

FIG. 3b illustrates a smartphone used as a connected intelligent vehicle head unit in a rear-facing configuration in accordance with an embodiment of the invention.

FIG. 4 illustrates a lean-to-steer control function using a smartphone camera in accordance with an embodiment of the invention.

FIG. 5 illustrates a trike sit and ride mode in accordance with an embodiment of the invention.

FIG. 6 illustrates a wheelchair sit and ride mode in accordance with an embodiment of the invention.

FIG. 7 illustrates a push assist mode in accordance with an embodiment of the invention.

FIG. 8 illustrates examples of optional attachments for multi-purpose use in accordance with an embodiment of the invention.

FIG. 9 illustrates a remote control mode in accordance with an embodiment of the invention.

FIG. 10 illustrates an autonomous lead-me mode in accordance with an embodiment of the invention.

FIG. 11 illustrates an autonomous follow-me mode in accordance with an embodiment of the invention.

FIG. 12 illustrates auto video capture with computer vision recognition in accordance with an embodiment of the invention.

FIG. 13 illustrates a folded configuration of a personal mobility vehicle in accordance with an embodiment of the invention.

FIG. 14 illustrates an electrical system block diagram in accordance with an embodiment of the invention.

FIG. 15 illustrates a motion control system with dynamic stability and traction control in accordance with an embodiment of the invention.

FIG. 16 illustrates a sliding and locking mechanism in accordance with an embodiment of the invention.

FIG. 17 illustrates a sliding and locking mechanism in accordance with an embodiment of the invention.

### DETAILED DESCRIPTION

Some embodiments of the present invention will now be described more fully hereinafter with reference to the accompanying drawings, in which some, but not all, embodiments of the invention are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus are not shown in one or more of the figures for clarity and to facilitate explanation of embodiments of the present invention.

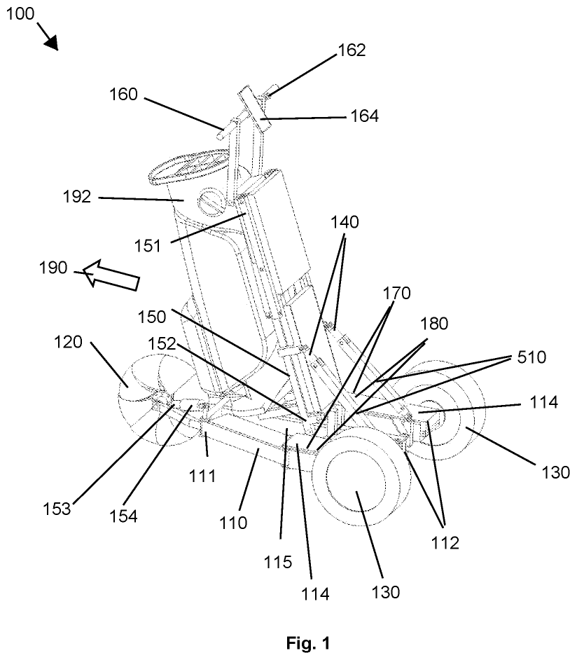

As shown in FIG. 1 a personal mobility vehicle 100 in a stand and ride configuration is shown. Personal mobility vehicle 100 may alternatively be referred to as vehicle 100, ProV3 100, ProV3 Personal Robotic Omni Vehicle 100, or a variation of any of these names without departing from the scope of the disclosure. The ProV3 Personal Robotic Omni Vehicle 100 is a cart/scooter comprising an aluminum (or otherwise lightweight structural material) folding frame, folding seat, adjustable handlebar 160 and grips, two electrically driven wheels 130, an omnidirectional wheel 120, rechargeable batteries 170, motor controls 180, sensors, user input controls, and a wireless charging mount for a Bluetooth-connected smartphone.

Frame

The frame consists of multiple sliding and hinged locking joints which allow the vehicle 100 to be configured and secured into multiple modes of operation, as well as to be folded into a compact form for storage or hauling, such as in an automobile trunk. Various optional frame attachments provide a means for carrying cargo, such as a golf bag 192 as shown in FIG. 1. In one embodiment, the frame comprises a base 110 that provides a stable base for vehicle 100 as well as a stable attachment structure for omnidirectional wheel 120, drive wheels 130, and other components of vehicle 100. In certain configurations of vehicle 100, the base 110 provides a stable footrest for a person standing or sitting on vehicle 100. Base 110 may be constructed from matching and opposing beams with generally rectangular cross sections wherein one of the beams is disposed on the left side of vehicle 100 and the other beam is disposed on the right side of vehicle 100. Each beam of base 110 may have a first end coupled to swing arm 153 which attach to omnidirectional wheel 120 and a second end coupled to one of the driven wheels 130. A non-skid foot pad 114 may be mounted at or near the second end 112 on the top side of each beam of base 110. In one embodiment the first end 111 of the left beam of base 110 couples to the left side swing arm 153 that attaches to the left side of omnidirectional wheel 120 and the second end 112 of the left beam of base 110 couples to the left driven wheel 130. Similarly, in one embodiment the first end 111 of the right beam of base 110 couples to the right side swing arm 153 that attaches to the right side of omnidirectional wheel 120 and the second end 112 of the right beam of base 110 couples to the right driven wheel 130. A central support beam 115 mounted between the right and left beams of base 110 allows for moving parts of the frame to slide and lock into place to achieve different configurations of vehicle 100.

The frame further comprises an upright frame support 150 having a first end 151 coupled to adjustable handlebar 160 and a second end 152 coupled to central support beam 115. Upright frame support 150 may be moved into various positions to achieve multiple configurations of vehicle 100. Upright frame support 150 is configured to slide along the length of central support beam 115 and lock into position.

A left support arm 140 hingedly connects the left side of upright frame support 150 to the left beam of base 110, and a right support arm 140 hingedly connects the right side of upright frame support 150 to the right beam of base 110. Support arms 140 provide additional support for the frame and other components of vehicle 100. One end of seat support braces 510 hingedly connect to support arms 140. In certain configurations of vehicle 100, such as the stand and ride configuration shown in FIG. 1, seat support braces 510 sit atop support arms 140 such that the support arms 140 are nested within the seat support braces 510. In other configurations of vehicle 100, such as the tricycle sit and ride configuration shown in FIG. 5, seat support braces 510 are rotated about their hinged ends attached to support arms 140 and their opposite ends are attached to seat 500, thus locking seat 500 securely into a position such that a person can ride vehicle 100 sitting on seat 500.

All components of the frame may be constructed of aluminum or any other suitable structural material. Attachments, such as the golf bag 192 shown in FIG. 1, may be attached to the frame to allow an operator to carry items while using vehicle 100.

A suspension system may be installed on vehicle 100 between omnidirectional wheel 120 and base 110. The suspension system may include a swing arm 153 and shock absorbers 154. The suspension system is configured to provide a smoother ride to a person riding on vehicle 100.

Adjustable Handlebar 160

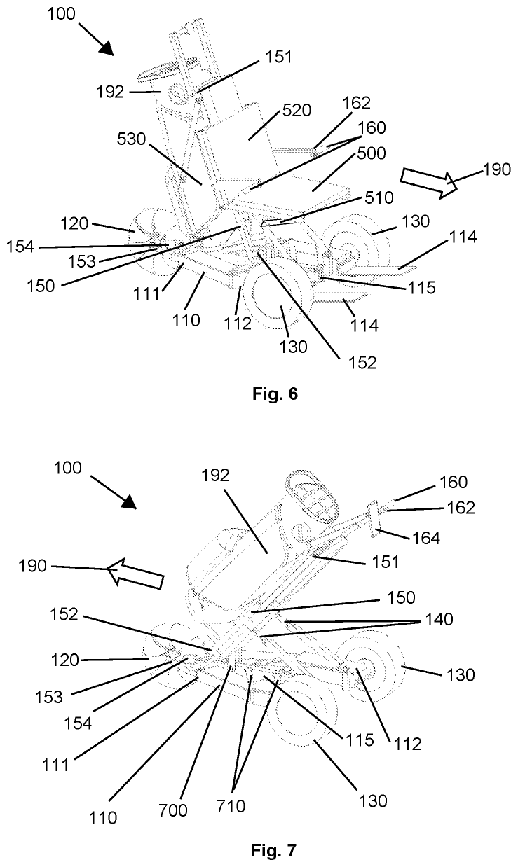

An adjustable handlebar, 160 with latching joint to lock into place, can be positioned to best fit operator height and comfort. Left and right handles with grips can be removed and attached to the frame in alternative locations, based on whether the vehicle is configured for stand and ride (FIG. 1) or sit and ride (FIG. 6) modes.

One or both hand grips include a user control input 162 for commanding the desired speed and yaw rate (steering) of vehicle 100. In one embodiment user control input 162 may comprise a thumbstick (multi-direction mini joystick operated with the thumb) on one handle. In other embodiments user control input 162 could include dual thumb throttles, thumb wheels, twist grips, or other potential rotary input sensing devices. The user control input 162 is electrically powered through either a physical connection to a battery (battery 170 or another power source) or a wireless electrical connection that automatically engages when the handle is attached to the frame.

The user's smartphone 164 is docked to a wireless charging mount attached to adjustable handlebar 160 and connected to the vehicle 100 via Bluetooth or via another wireless or wired connection to vehicle 100. Software running on smartphone 164 provides the user display and interface for interacting with the vehicle 100. In one embodiment smartphone 164 comprises a smartphone having a touchscreen and camera such as an iPhone or Android phone; however, smartphone 164 may also comprise a tablet or similar device having a touchscreen and camera without departing from the scope of the disclosure.

The vehicle 100 is propelled and steered by two electrically driven wheels 130. Electrically driven wheels 130 may be referred to as drive wheels 130 or wheels 130 without departing from the scope of the disclosure. In one embodiment, drive wheels 130 comprise brushless DC hub motors with tires designed for traction and off-road use while also minimizing compaction and damage to turf or other surfaces. Both left and right drive wheels 130 are electrically controlled independently by a motor controller 180 to control vehicle speed and yaw when operated at different speeds to provide differential steering. Each drive wheel 130 may also include an electromagnetic park brake which can be electrically engaged and disengaged to automatically lock the motors and thus the drive wheels 130 when stopped to eliminate roll, and automatically unlock the motors and thus the drive wheels 130 when the user commands motion of vehicle 100 using user control input 162 or software running on smartphone 164. In one embodiment, the left drive wheel 130 is mounted on the outside edge of the left beam of base 110 at or near the second end 112 of the left beam of base 110, and the right drive wheel 130 is mounted on the outside edge of the right beam of base 110 at or near the second end 112 of the right beam of base 110. Power for drive wheels 130 is provided by batteries 170.

Integrated electro-magnetic park brakes in drive wheels 130 automatically engage when there is no user command from user control input 162 or smartphone 164, or can be manually disengaged for free wheel operation.

Omnidirectional Wheel 120

An unpowered omnidirectional wheel 120 mounted to base 110 allows unrestricted motion in any direction, like a caster wheel, while providing improved strength, stability, and functionality for the vehicle 100 through all modes of operation and dynamically through turns. The omni wheel 120 is mounted to a suspended swing arm 153 with shock absorbers 154 to provide a smoother ride of vehicle 100 over rough surfaces. Omnidirectional wheel 120 may also be referred to as omni wheel 120 or omni-directional wheel 120 without departing from the scope of the disclosure.

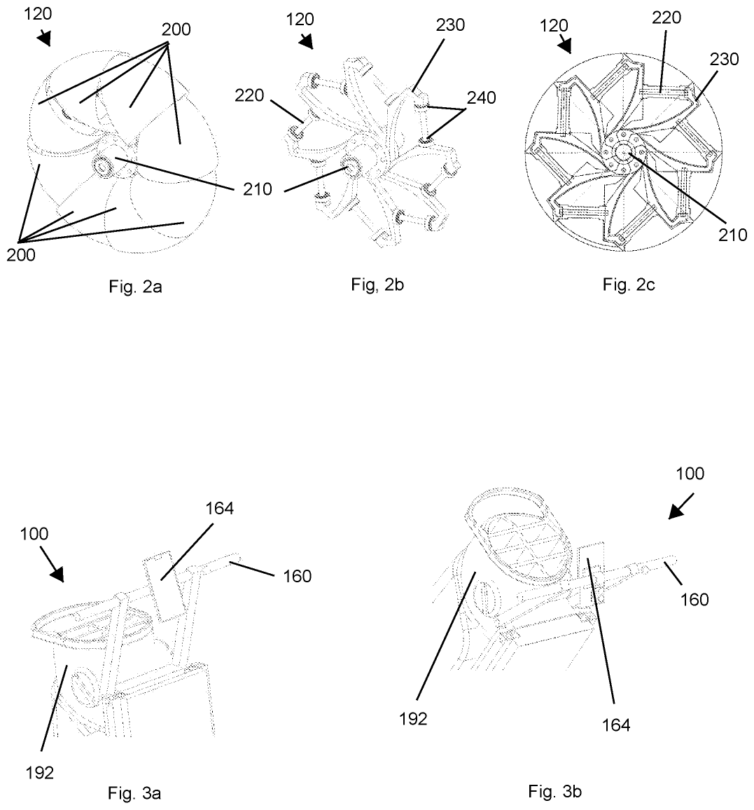

FIGS. 2a, 2b, and 2c provide more detailed illustrations of the omni wheel 120 design. FIG. 2a illustrates an assembled view of omnidirectional wheel 120. FIG. 2b illustrates a omnidirectional wheel 120 without rollers 200. FIG. 2c illustrates a cross-sectional view of assembled omnidirectional wheel 120. The omni wheel 120 is mounted to the swing arm 153 or fork with a primary axle through the omni wheel 120 hub 210 with bearings. The omni wheel 120 rotates freely forward and backwards around this primary axle as in a typical motorcycle or scooter wheel. In one embodiment there are 8 spokes 230 made of aluminum or another lightweight structural material securely attached with bolts between the 2 primary hubs 210. The spokes 230 provide support for 8 roller axles 220 that are oriented perpendicular to the primary axle. Rollers 200 are attached between the spokes 230 and around the roller axles 220, supported by small bearings 240 which may be the same or similar to in-line skate or skateboard wheel bearings. The rollers 200 are designed with a curved, conical shape that together provide a smooth and continuous outer surface for the omni wheel 120. The rollers 200 are nested inside one another with a very small gap between each roller 200 such that the outer surface of the omnidirectional wheel 120 is continuous for smooth operation. In one embodiment, the gap between rollers 200 is 0.055 inches. The rollers 200 rotate perpendicular to the primary axle and allow the omni wheel 120 to move freely left or right. The rollers 200 are made of either plastic or aluminum, overmolded with polyurethane for softer and quieter operation on all types of surfaces. FIG. 2b shows the omni wheel 120 with the rollers 200 hidden to show the design of the spokes 230 and roller axles 220 with bearings 240. FIG. 2b depicts eight roller axles 220, 8 spokes 230, and sixteen bearings 240 (one on each end of each roller axle 220) occurring in identical patterns around the circumference of omnidirectional wheel 120; however, for the sake of readability of the drawing only one example of each is labelled. FIG. 2c shows a cross-section view of omnidirectional wheel 120 to show how the rollers 200 nest together and the entire assembly fits uniquely together to provide smooth and free operation in all directions. FIG. 2c depicts eight roller axles 220 and 8 spokes 230 occurring in identical patterns around the circumference of omnidirectional wheel 120; however, for the sake of readability of the drawing only one example of each is labelled.

This omni wheel 120 design is advantageous compared to other wheel designs due to the simplicity and small number of components, the ease of assembly, the roller 200 and spoke 230 shape that allows them to nest inside of one another around the omnidirectional wheel 120, the large roller 200 diameter that allows smooth lateral movement over all types of terrain with minimal compaction or damage to turf, the small gap between rollers 200 that allows smooth and quiet operation, and the overall compact size and shape while still structurally strong and functionally efficient.

In one embodiment, omnidirectional wheel 120 may have an overall assembled outer diameter of approximately 12.5 inches. Each roller axle 220 may have a length of approximately 3.061 inches and a diameter of 0.313 inches. Each roller 200 may be constructed from approximately 0.25-inch-thick polyurethane with a length of approximately 4.426 inches, a large end diameter of approximately 4.754 inches and a small end diameter of approximately 1.4 inches. Other dimensions and materials may be used for omnidirectional wheel 120 without departing from the scope of the disclosure.

While vehicle 100 is shown with one omnidirectional wheel 120, one or more additional omnidirectional wheels 120 may be used without departing from the scope of the disclosure. For example, vehicle 100 may include two omnidirectional wheels 120 in alternative embodiments.

Modes of Operation

As previously described, the frame of vehicle 100 comprises several hinged sections configured to slide and lock into places such that vehicle 100 can be operated in a number of modes or configurations.

Stand and Ride Mode

FIG. 1 shows the vehicle 100 configured in a stand and ride mode with a golf bag attachment 192 and indication of forward direction of travel 190. The operator stands on the left and right foot pads 114 on top of the battery 170 compartments located in base 110, places hands on the adjustable handlebar 160, and rides the vehicle 100 similar to a typical scooter. Typical use could be on a golf course, providing the golfer with a faster, easier, more enjoyable method of moving around the course independently with their own cart and able to play their own ball, resulting in a much improved experience and shorter rounds. The center of gravity is kept low and centered between the two driven wheels 130 and omnidirectional wheel 120 to enhance stability on hills and side slopes.

In the stand and ride configuration, the second end 152 of upright frame support 150 is slid along central support beam 115 and locked into place in a generally upright position. In this configuration, the second end 152 of upright frame support 150 may be positioned approximately halfway between the first end 111 and second end 112 of base 110 such that upright frame support 150 is vertical or slightly angled. Support arms 140 connect between upright frame support 150 and base 110 to provide additional support and stability for upright frame support 150. Adjustable handlebar 160 is installed at the first end of upright frame support 150 to provide support for the operator while standing on the vehicle 100. Adjustable handlebar 160 may be rotated and locked into place in the position most comfortable for the operator. User control input 162 is positioned on the adjustable handlebar 160 and positioned for the operator's comfort. The operator's smartphone 164 is positioned on the adjustable handlebar 160 such that the touchscreen and forward-facing camera of the smartphone 164 is facing the operator and the operator may interact with smartphone 164 to control the vehicle 100. By operating the user control input 162 or user interface software running on smartphone 164, the operator can command the motor controllers 180 to operate, causing drive wheels 130 to operate and move vehicle 100.

Smartphone Operation

As shown in FIGS. 3a and 3b, multiple advanced functions are provided by the user's smartphone 164 when used with the software application associated with the vehicle 100 for interfacing with and controlling the vehicle 100. As smartphones 164 with advanced capabilities are now ubiquitous, they provide a cost-effective and personalized solution as the intelligent head unit for the vehicle 100. Through the smartphone 164 app, the vehicle 100 owner can configure the vehicle 100 in personal secured mode (only authorized users), rideshare secured mode (only paying customers), or unsecured mode (anyone can use). In a secured mode, the smartphone authenticates the user (through its inherent secure identification methods or through a rideshare app) before allowing the vehicle 100 to be operated. The owner can also configure all vehicle 100 settings and preferences through the smartphone 164 app.

During operation, the connected smartphone 164 provides the vehicle 100 operating display for information such as speed, power utilization, odometer, battery charge, range, operating mode, notifications, etc. The smartphone's 164 built-in touchscreen, speaker, voice recognition, gesture recognition, and inertial measurement unit (IMU) also provide the user interface for the operator to select modes and preferences, as well as to command and control the vehicle 100 in a personalized way. The smartphone's 164 embedded machine learning capabilities, along with cloud-connectivity, allow the smartphone 164 app to learn and adapt to operator behavior to provide the most intuitive and enjoyable riding experience. Smartphone 164 cellular connectivity and data plan provides the cloud-connectivity for data analytics, software updates, remote diagnostics, fleet management, and rideshare logistics and financial transactions.

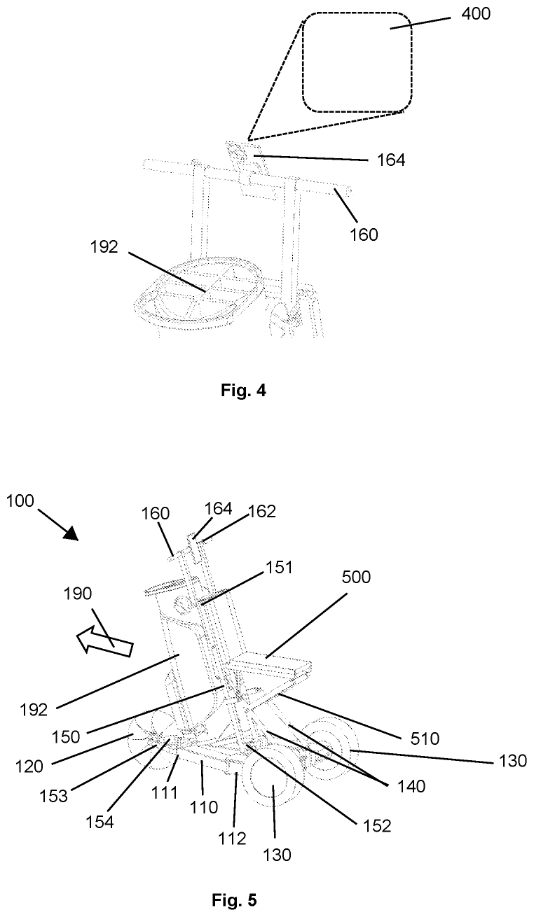

As shown in FIG. 3a, in some front-facing configurations of vehicle 100 such as stand and ride mode (FIG. 1) or trike sit and ride mode (FIG. 5), smartphone 164 is positioned such that the touchscreen and front-facing camera of smartphone 164 are facing the operator. In these configurations, the smartphone's 164 front-facing camera and built-in computer vision capabilities can be used to control the vehicle 100 by visually tracking the location of the rider's head and torso, such that the operator can steer the vehicle 100 simply by leaning left or right, and/or control the speed by leaning forward or backward, a capability hereafter referred to as “ProVision.” As shown in FIG. 4, an image 400 of the rider's position is captured in the view of the camera of smartphone 164. When the operator leans right the vehicle 100 is steered to the right as a result of tracking the rider image 400. Similarly, when the operator leans left the vehicle 100 turns left as a result of tracking the rider image 400. This provides an intuitive and enjoyable method of controlling the vehicle 100 while also aiding in vehicle 100 stability by matching vehicle 100 dynamics with shifting center of gravity of the rider. In these configurations, in addition to providing operator position tracking, the smartphone 164 may also provide secure operator identification, gesture control, voice control, audio capabilities, inertial measurement unit (IMU), computer vision, machine leaning, cloud connectivity, fleet management, remote diagnostics, software updates, ridesharing applications, and third-party applications. While the smartphone 164 is shown with touchscreen and front-facing camera facing the operator of vehicle 100 in FIG. 3a such that the operator may view and use smartphone 164, smartphone 164 may alternatively be rotated such that the rear-facing camera faces the operator and is used to guide the vehicle 100.

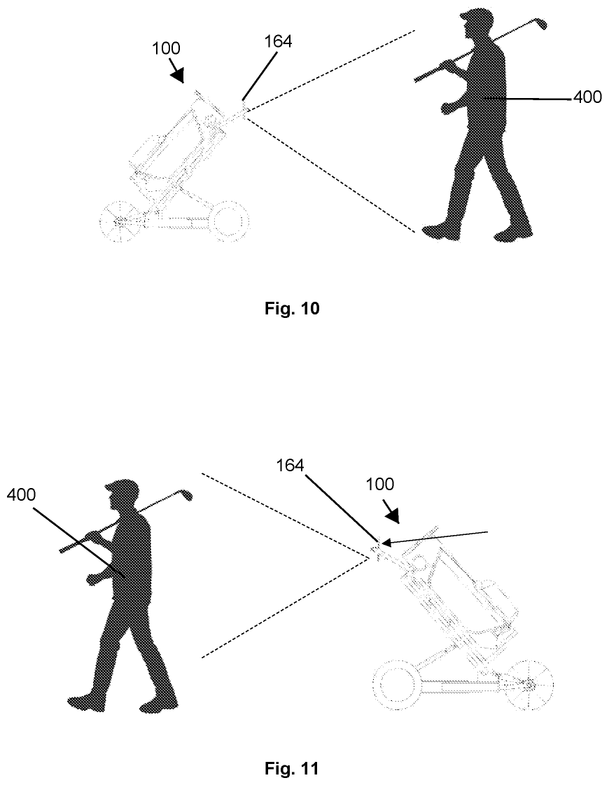

As shown in FIG. 3b, in other rear-facing configurations of vehicle 100, such as autonomous lead-me mode (FIG. 10) or autonomous follow-me mode (FIG. 11), the smartphone 164 can be rotated around the adjustable handlebar 160 to utilize the rear-facing camera and ProVision software running on the smartphone 164 to identify and track the operator position and gestures at further distances in order to automatically control the vehicle 100 remotely when the operator is not riding on the vehicle 100. Based on predefined settings and preferences, the vehicle 100 will maintain a consistent distance from the operator, maintain a synchronized pace, move in the same direction, and respond to operator gestures and voice commands. In these configurations, in addition to providing operator position tracking, the smartphone 164 may also provide obstacle detection, gesture control and automatic video capture. While the smartphone 164 is shown with rear-facing camera facing the operator of vehicle 100 in FIG. 3b such that the generally more capable rear-facing camera of smartphone 164 is used for guidance purposes, smartphone 164 may alternatively be rotated such that the touchscreen and front-facing camera face the operator and the front-facing camera is used to guide the vehicle 100.

As shown in FIG. 10, in autonomous lead-me mode, vehicle 100 is configured in push assist mode with the operator walking behind the vehicle 100. Smartphone 164 is positioned such that the rear-facing camera face the operator, and an image 400 of the operator is captured by the camera of smartphone 164. Software running on smartphone 164 uses computer vision and machine learning to track the operator's position for navigation of vehicle 100. Human gestures are used to command the mode of vehicle 100, start and stop vehicle 100, and increase or decrease distance between vehicle 100 and the operator.

As shown in FIG. 11, in autonomous follow-me mode, vehicle 100 is configured in push assist mode with the operator walking in front of the vehicle 100. Smartphone 164 is positioned such that the rear-facing camera face the operator, and an image 400 of the operator is captured by the camera of smartphone 164. Software running on smartphone 164 uses computer vision and machine learning to track the operator's position for navigation of vehicle 100. Human gestures are used to command the mode of vehicle 100, start and stop vehicle 100, and increase or decrease distance between vehicle 100 and the operator.

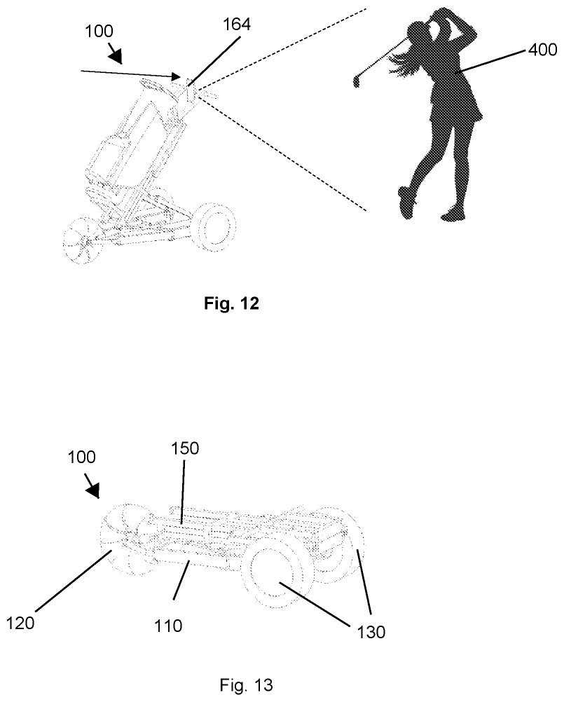

Another capability of the ProVision software built into the vehicle 100 smartphone app (FIG. 12) is to track the operator with computer vision, automatically recognize certain activity that it has been trained for (i.e., hitting a golf ball), and automatically capture video of the action for later video documentation, sharing, or analysis. Similar to drone technology that tracks and videos a person's activities, the vehicle 100 with smartphone 164 can automatically track and record activities of interest, which could be quite beneficial, for example, to a golfer for analyzing their swing and diagnosing potential causes of each shot outcome. As shown in FIG. 12, the vehicle 100 is configured in push assist mode. Smartphone 164 is positioned such that the rear-facing camera of smartphone 164 are facing the operator, and an image 400 of the operator is captured by the camera of smartphone 164. Smartphone 164 uses computer vision and artificial intelligence to recognize activity and automatically capture a video clip.

The smartphone 164 can also be used in remote control mode (FIG. 9), where the operator can control the vehicle 100 through either a virtual joystick on the touchscreen of the smartphone 164, or through utilizing the smartphone 164 inertial measurement unit (IMU) and controlling the vehicle 100 simply by the orientation of the smartphone 164 roll and pitch. In the remote control mode, smartphone 164 communicates with motor controllers 180 of the vehicle 100 through Bluetooth vehicle interface or through another wired or wireless communication protocol. This mode can be useful in golf when you might want to send the vehicle 100 on ahead to the other side of the green or to the next tee box.

Trike Sit and Ride Mode

FIG. 5 shows the vehicle 100 configured in the trike sit and ride mode, where the operator can sit if preferred with the direction of forward travel 190 indicated. The seat 500 is manually rotated up and secured by snapping seat support braces 510 into place under the seat 500. In this mode, the operator sits on the seat 500 facing in the forward direction with legs straddling the upright frame support 150 and feet resting on the beams of base 110. Similar to other modes of operation, the operator controls the speed and direction of vehicle 100 through the user control input 162, software running on smartphone 164, or by using ProVision lean-to-steer functionality which changes the direction of vehicle 100 based on the direction the operator leans. In this configuration, the drive wheels 130 are still in the rear for normal forward direction 190, which is the preferred orientation for dynamic stability at higher speeds.

In the trike sit and ride configuration, the second end 152 of upright frame support 150 is slid along central support beam 115 and locked into place in a generally upright position. In this configuration, the second end 152 of upright frame support 150 may be positioned approximately halfway between the first end 111 and second end 112 of base 110 such that upright frame support 150 is vertical or slightly angled. Support arms 140 connect between upright frame support 150 and base 110 to provide additional support and stability for upright frame support 150. Seat support braces 510 are raised and snap onto seat 500 to provide stable support for seat 500. Adjustable handlebar 160 is installed at the first end of upright frame support 150 to provide support for the operator while sitting on the seat 500 of the vehicle 100. Adjustable handlebar 160 may be rotated and locked into place in the position most comfortable for the operator. User control input 162 is positioned on the adjustable handlebar 160 and positioned for the operator's comfort. The operator's smartphone 164 is positioned on the adjustable handlebar 160 such that the touchscreen and forward-facing camera of the smartphone 164 is facing the operator and the operator may interact with smartphone 164 to control the vehicle 100. By operating the user control input 162 or user interface software running on smartphone 164, the operator can command the motor controllers 180 to operate, causing drive wheels 130 to operate and move vehicle 100.

Wheelchair Sit and Ride Mode

As shown in FIG. 6, by folding down the armrests 530, moving the handles of adjustable handlebar 160 to the outer ends of armrests 530, and unfolding the foot pads 114, the vehicle 100 is configured into wheelchair sit and ride mode. The seat 500 and upright frame support 150 spread apart through frame linkages to allow a wider comfortable seat, with the elastic fabric over the seat cushions 500 and 520 expanding to conform to the shape and size of seat 500 and upper cushion 520 in the expanded configuration. In this mode, the drive wheels 130 are in the front and the omni wheel 120 in the rear, providing a high degree of maneuverability with sufficient dynamic stability for the limited operating speeds in this mode. For the golfer, this may provide a more relaxing and enjoyable method of moving around the golf course, or to sit and rest when waiting for others. In other applications, this mode provides convenient mobility assistance similar to other electric wheelchairs, although with a more compact and portable design.

In the wheelchair sit and ride configuration, the second end 152 of upright frame support 150 is slid along central support beam 115 and locked into place in a generally upright position. In this configuration, the second end 152 of upright frame support 150 may be positioned approximately halfway between the first end 111 and second end 112 of base 110 such that upright frame support 150 is vertical or slightly angled. Support arms 140 connect between upright frame support 150 and base 110 to provide additional support and stability for upright frame support 150. Seat support braces 510 may be raised and snap onto seat 500 to provide stable support for seat 500. In other configurations of vehicle 100, armrests 530 are placed in their storage position parallel to upright frame support 150; however for wheelchair sit and ride configuration, armrests 530 are unfolded and locked into place with one armrest 530 locked into place on each side of seat 500 and upper seat cushion 520. Armrests 530 may be padded for the operator's comfort. The handles are removed from adjustable handlebar 160 and placed on the outer ends of armrests 530 to provide support for the operator while sitting on the seat 500 of the vehicle 100. User control input 162 is positioned on one side of the adjustable handlebar 160 and positioned for the operator's comfort. By operating the user control input 162, the operator can command the motor controllers 180 to operate, causing drive wheels 130 to operate and move vehicle 100.

Push Assist Mode

FIG. 7 shows the vehicle 100 configured in push assist mode, where the operator walks behind the vehicle 100 similar to a golf pushcart or shopping cart. In this mode, the vehicle 100 can be operated by the user control input 162 on the handlebar 160, or optionally or in combination with the ProVision capability of the smartphone 164 app to track the operator position relative to the vehicle 100. In this configuration the vehicle 100 can also be operating manually in free wheel mode with the power off and parking brakes released. Integrated electro-magnetic park brakes in drive wheels 130 automatically engage when there is no user command from user control input 162 or smartphone 164, or can be manually disengaged for free wheel operation. For the golfer, this mode may be desired when preferring to walk and get more exercise.

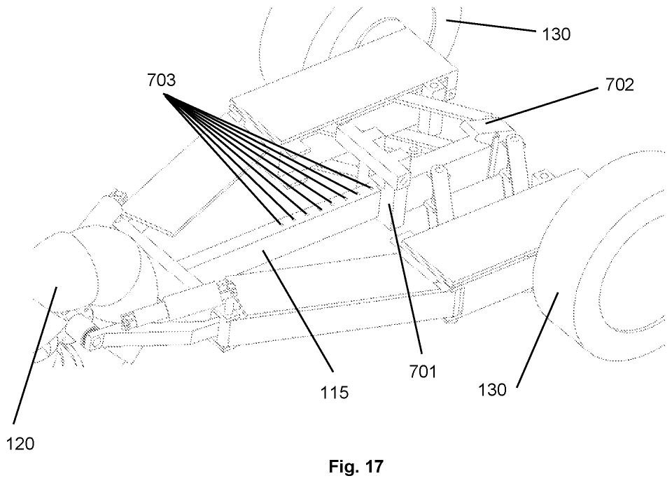

Although present in all configurations of vehicle 100, sliding and locking mechanism 700 is particularly easy to view in FIG. 7. Sliding and locking mechanism 700 allows components of the frame of vehicle 100 to be folded and snapped into place to achieve the various configurations and frame orientations of vehicle 100. As shown in FIGS. 16 and 17, in one embodiment, sliding and locking mechanism 700 comprises a foot-actuated latch mechanism for locking the upright frame support 150 (not shown in FIGS. 16 and 17) to the central support beam 115. The lower end 152 of the upright frame support 150 connects to a sliding mechanism 701. An over-center rocker latch 702 pivots around a center axis with a spring-loaded or other elastic tension chord that holds the rocker latch down securely in a locked or unlocked position. In the locked position, a pin on the latch 702 engages into one of many holes 703 in the central support beam 115 to secure the upright frame support 150 so it is locked in position relative to the central support beam 115. With a series of frame holes 703 with consistent spacing (for instance one hole 703 every 1 inch), the sliding mechanism 701 can be locked into one of many optional positions for configuring the vehicle frame into various modes of operation and allowing the operator to select the positions most suited to their preferences. Many other locking and latching mechanisms could be utilized, either off-the-shelf or custom-designed, for securing the upright frame support 150 to the central support beam 115 with a simple hand or foot action.

Similarly to sliding and locking mechanism 700, linkage arms 710 are present in all configurations of vehicle 100, but are particularly easy to view in FIG. 7. Linkage arms 710 maintain frame geometry and structure.

In the push assist configuration, the second end 152 of upright frame support 150 is slid along central support beam 115 and locked into place using sliding and locking mechanism 700 in an angled position. In this configuration, the second end 152 of upright frame support 150 may be positioned at or near the first end 111 of base 110. Support arms 140 connect between upright frame support 150 and base 110 to provide additional support and stability for upright frame support 150. Adjustable handlebar 160 is installed at the first end of upright frame support 150 to provide support for the operator while pushing vehicle 100. Adjustable handlebar 160 may be rotated and locked into place in the position most comfortable for the operator. User control input 162 is positioned on the adjustable handlebar 160 and positioned for the operator's comfort. The operator's smartphone 164 is positioned on the adjustable handlebar 160 such that the touchscreen and forward-facing camera of the smartphone 164 is facing the operator and the operator may interact with smartphone 164 to control the vehicle 100. By operating the user control input 162 or user interface software running on smartphone 164, the operator can command the motor controllers 180 to operate, causing drive wheels 130 to operate and move vehicle 100.

Attachments

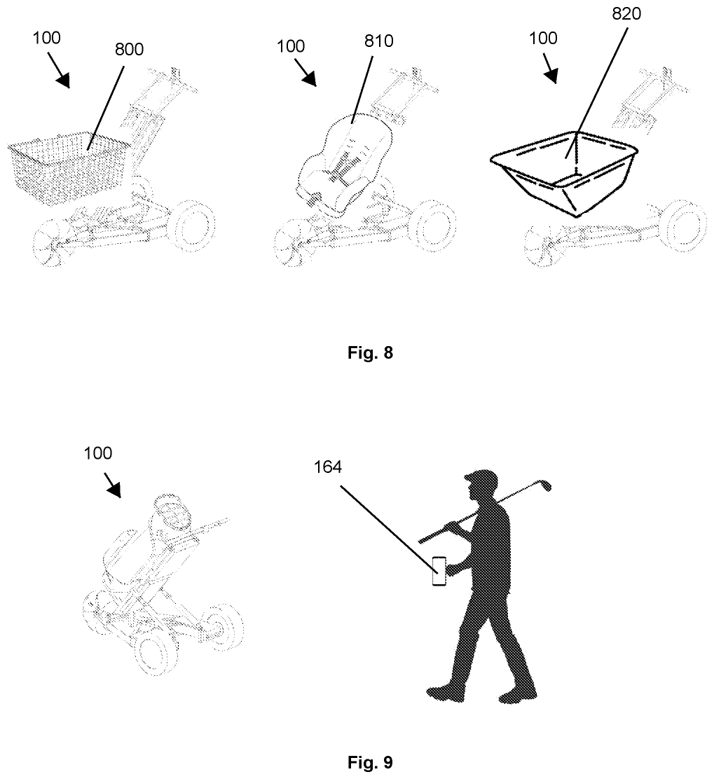

FIG. 8 shows a few examples of the many potential cargo attachments and applications for the vehicle 100. In addition to carrying a golf bag 192, vehicle 100 may carry a shopping basket 800, child seat 810, or wheelbarrow 820. The versatile vehicle 100 platform can provide an intelligent and convenient solution for shopping carts, strollers, utility carts, factory material transport, and many others. The versatility of the vehicle 100 provides greater value in leveraging the vehicle 100 investment for many users across many applications.

Folded Configuration

With the vehicle's 100 folding frame, lightweight materials, and compact design, it can be folded down into a fold and stow mode as shown in FIG. 13, where it is about the size of a bag of golf clubs, for convenient storage or transporting in the trunk of an automobile.

Electrical System and Software Control System

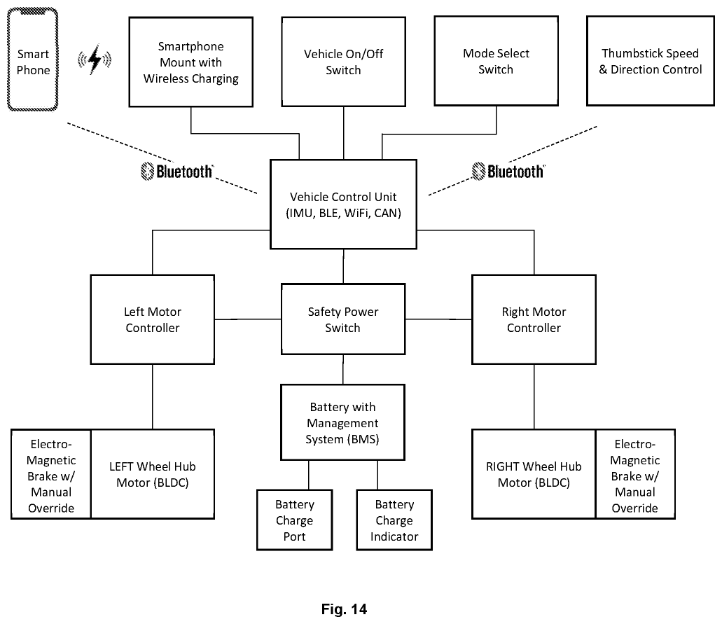

FIG. 14 shows a simplified block diagram of the electrical system, components, and connections of vehicle 100.

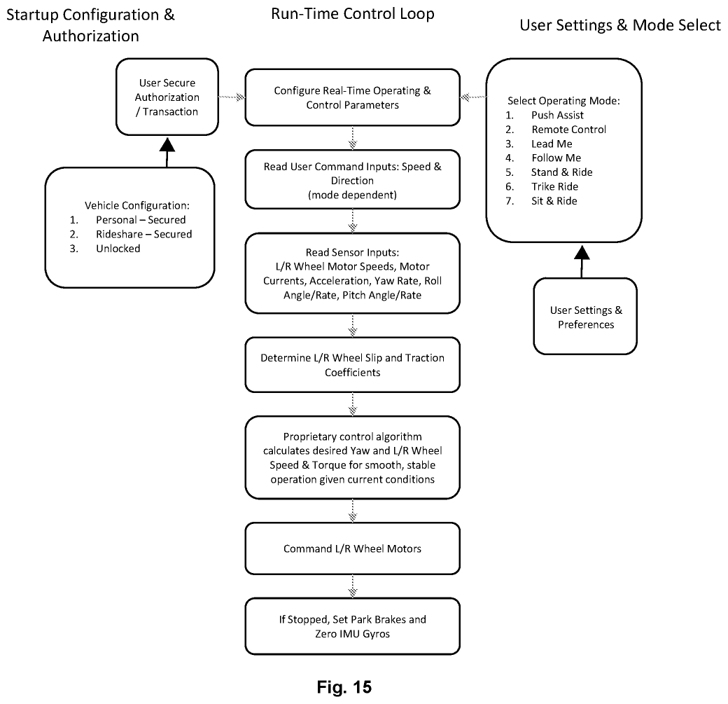

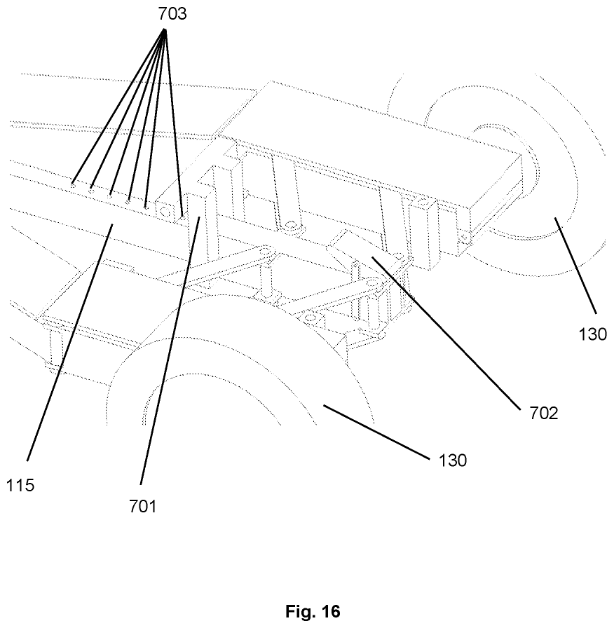

FIG. 15 shows a simplified view of the software control system, distributed between the smartphone 164 app, user control input 162, and left/right motor controllers 180. The motion control system utilizes multiple inertial and speed sensors, along with intelligent control algorithms, to dynamically control stability and traction in all variety of surface conditions and terrain, to minimize wheel slip, maintain smooth and predictable steering, acceleration, and braking response, and to prevent tipping.

The disclosed vehicle 100 is differentiated from competitors due to its versatile all-in-one solution for multiple applications and modes of operation, all in a simple, affordable, portable, and highly intelligent design. It includes a superior omni wheel 120 design for smooth, functional, and stable maneuverability across all terrains including turf. Using deep integration with smartphone 164 capabilities, the vehicle 100 provides secure autonomous, robotic operation using computer vision and machine learning. Intelligent control systems and user interfaces that learn and adapt to users and their environment make the vehicle 100 more stable, safe, intuitive, and easy to use for all demographics.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A personal mobility vehicle comprising:
a base having a first end and a second end,
one or more non-powered omnidirectional wheels mounted to the first end of the base;
two independently controlled driven wheels with electric hub motors mounted to the second end of the base; and
a frame mounted to the base wherein the frame is configured to be folded and locked into a plurality of configurations.

2. The personal mobility vehicle of claim 1 wherein the plurality of configurations comprises a stand and ride mode, a tricycle sit and ride mode, a wheelchair sit and ride mode, a push-assist mode, a remote control mode, an autonomous lead-me mode, an autonomous follow-me mode, and a folded stow and go mode.

3. The personal mobility vehicle of claim 1 wherein the driven wheels with electric hub motors are configured to provide propulsion and differential steering to the personal mobility vehicle.

4. The personal mobility vehicle of claim 1 further comprising attachment points for mounting one or more attachments.

5. The personal mobility vehicle of claim 4 wherein the attachments comprise one or more of a golf bag, a shopping basket, a child seat, or a wheelbarrow.

6. The personal mobility vehicle of claim 1 wherein the vehicle is configured to be controlled by image recognition software running on a smartphone.

7. The personal mobility vehicle of claim 6 wherein the image recognition software is configured to recognize one or more gestures made by an operator of the personal mobility vehicle and alter an action of the personal mobility vehicle in response to the one or more gestures.

8. The personal mobility vehicle of claim 7 wherein the gesture recognized by the image recognition software comprises leaning and the action of the personal mobility vehicle comprises steering in the direction of the leaning.

9. The personal mobility vehicle of claim 7 wherein the gesture recognized by the image recognition software comprises walking behind the personal mobility vehicle and the action of the personal mobility vehicle comprises traveling ahead of the operator.

10. The personal mobility vehicle of claim 7 wherein the gesture recognized by the image recognition software comprises walking in front of the personal mobility vehicle and the action of the personal mobility vehicle comprises traveling behind the operator.

11. The personal mobility vehicle of claim 7 wherein the gesture recognized by the image recognition software comprises a golf swing and the action of the personal mobility vehicle comprises recording a video.

12. The personal mobility vehicle of claim 1 wherein the personal mobility vehicle is configured to be controlled by security software running on a smartphone, and wherein the security software is configured to verify that an operator is authorized to use the personal mobility vehicle before the personal mobility vehicle will operate.

13. The personal mobility vehicle of claim 1 wherein the personal mobility vehicle is configured to be controlled by rideshare software running on a smartphone, and wherein the rideshare software is configured to verify that an operator has paid to use the personal mobility vehicle before the personal mobility vehicle will operate.

14. The personal mobility vehicle of claim 1 further comprising a dynamic traction control system configured to maintain stability and differential steering integrity across different types of terrain and surface conditions.

15. The personal mobility vehicle of claim 1 wherein the personal mobility vehicle comprises a battery powered electric vehicle.

16. An omnidirectional wheel comprising:
a central hub,
a plurality of spokes radiating outwardly from the central hub;
a plurality of roller axles wherein each roller axle has a first end and a second end and wherein the first end of each roller axle connects to a spoke associated with the roller axle and the second end of each roller axle connects to an adjacent spoke;
a plurality of bearings installed on each roller axle; and
a plurality of nested rollers wherein each roller is installed on a roller axle supported by bearings and wherein each roller is configured to rotate about the roller axle it is installed upon.

17. The omnidirectional wheel of claim 16 wherein each roller comprises a curved conical shape.

18. The omnidirectional wheel of claim 16 wherein a first end of each roller is nested within a second end of an adjacent roller such that the plurality of nested rollers form a continuous outer surface of the omnidirectional wheel.
